(19) United States
(12) Patent Application Publication
(10) Pub. No.: US 2006/0232188 A1
(43) Pub. Date: Oct. 19, 2006

(54) Flat image display device

(76) Inventors: Akiyoshi Yamada, Fukaya-shi (JP); Hiromitsu Takeda, Kawasaki-shi (JP); Hirotaka Unno, Fukaya-shi (JP); Yuichi Shinba, Hiratsuka-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/452,362

(22) Filed: Jun. 14, 2006

Related U.S. Application Data
(63) Continuation of application No. PCT/JP04/18753, filed on Dec. 15, 2004.

(30) Foreign Application Priority Data
Dec. 25, 2003 (JP) 2003-429754

(51) Int. Cl. H01J 1/62

(52) U.S. Cl. 313/496

(57) ABSTRACT

A flat image display device includes two glass substrates located opposite each other with a gap therebetween and a seal portion which seals a predetermined position on the glass substrates and defines a sealed space between the two glass substrates. The seal portion having a low-melting-point metal filled along the predetermined position and a metal layer provided between respective surfaces of the glass substrates and low-melting-point metal and formed of a metal which has connectivity to glass, affinity to the low-melting-point metal, and a solubility of less than 1% to the low-melting-point metal to be melted at a temperature of 500° C. or less.

### CROSS-REFERENCE TO RELATED APPLICATIONS

This is a Continuation Application of PCT Application No. PCT/JP2004/018753, filed Dec. 15, 2004, which was published under PCT Article 21(2) in Japanese.

This application is based upon and claims the benefit of priority from prior Japanese Patent Application No. 2003-429754, filed Dec. 25, 2003, the entire contents of which are incorporated herein by reference.

### BACKGROUND OF THE INVENTION

1. Field of the Invention

This invention relates to a flat image display device having substrates located opposite each other and a vacuum seal structure that seals the substrates together.

2. Description of the Related Art

In recent years, flat image display devices have been recognized as image display devices that are remarkable in view of efficient space utilization or other design factors. Among others, an image display device of an electron emission type, such as a field emission device (hereinafter referred to as an FED), is expected as an excellent display that has merits of high luminance, high resolution, lower power consumption, etc.

In general, a flat image display device comprises two substrates that are located opposite each other in a spaced manner and formed of a glass plate each. These substrates have their respective peripheral edge portions sealed together to form an envelope. It is important to keep the space between the two substrates, that is, the interior of the envelope, at a high degree of vacuum. If the degree of vacuum is low, the life of electron emitting elements and hence the life of the device is inevitably reduced.

In maintaining a high vacuum in this narrow space, it is hard to use an organic sealing material that is permeable to gas, even though very little. It is essential, therefore, to use an inorganic adhesive or sealant as the sealing material. Thus, according to a device disclosed in Jpn. Pat. Appln. KOKAI Publication No. 2002-319346, for example, low-melting-point metals, such as In and Ga, are used as sealing materials to bond glass substrates together or form vacuum seals. If these low-melting-point metals are heated to their melting points and melted, they can perform highly airtight sealing, owing to their high wettability with glass.

In some flat image display devices, however, the peripheral length of their substrates may exceed 3 meters, and wider areas must be sealed than in conventional cathode-ray tubes and the like. Therefore, factors of induction of sealing defects are nearly a hundred times as many as in the cases of cathode-ray tubes and the like, so that sealing the substrates is a very hard operation. Features of some flat image display devices require strict vacuum specifications of their envelopes, so that heat treatment may be carried out at a temperature much higher than the melting point of the sealing material. Under this high-temperature heat treatment, the wettability of the sealing material with glass lowers, so that the sealing material cannot display a satisfactory bonding or sealing effect. In consequence, a problem has started to arise such that a large-sized device kept at a high degree of vacuum cannot be manufactured.

### BRIEF SUMMARY OF THE INVENTION

This invention has been made in consideration of these circumstances, and its object is to provide a flat image display device capable of maintaining a high degree of vacuum and having improved reliability.

In order to achieve the object, according to an aspect of the invention, there is provided a flat image display device comprising: two glass substrates located opposite each other with a gap therebetween; and a seal portion which seals a predetermined position on the glass substrates and defines a sealed space between the two glass substrates, the seal portion having a low-melting-point metal filled along the predetermined position and a metal layer provided between respective surfaces of the glass substrates and low-melting-point metal and formed of a metal which has connectivity to glass, affinity to the low-melting-point metal, and a solubility of less than 1% to the low-melting-point metal to be melted at a temperature of 500° C. or less.

According to another aspect of the invention, there is provided a flat image display device comprising: two glass substrates located opposite each other with a gap therebetween; and a seal portion which seals a predetermined position on the glass substrates and defines a sealed space between the two glass substrates, the seal portion having a low-melting-point metal filled along the predetermined position, a metal layer provided between respective surfaces of the glass substrates and the low-melting-point metal and formed of a metal which has connectivity to glass, affinity to the low-melting-point metal, and a solubility of less than 1% to the low-melting-point metal to be melted at a temperature of 500° C. or less, and a protective layer provided between the metal layer and the low-melting-point metal and having affinity to the low-melting-point metal.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an SED according to a first embodiment of this invention;

FIG. 2 is a perspective view of the SED cut away along line II-II of FIG. 1;

FIG. 3 is a sectional view enlargedly showing a seal portion of the SED;

FIG. 4 is a sectional view showing another embodiment of the seal portion;

FIG. 5 is a sectional view showing still another embodiment of the seal portion; and

FIG. 6 is a sectional view showing another embodiment of the seal portion.

### DETAILED DESCRIPTION OF THE INVENTION

Embodiments in which a flat image display device according to this invention is applied to an FED will now be described in detail with reference to the drawings.

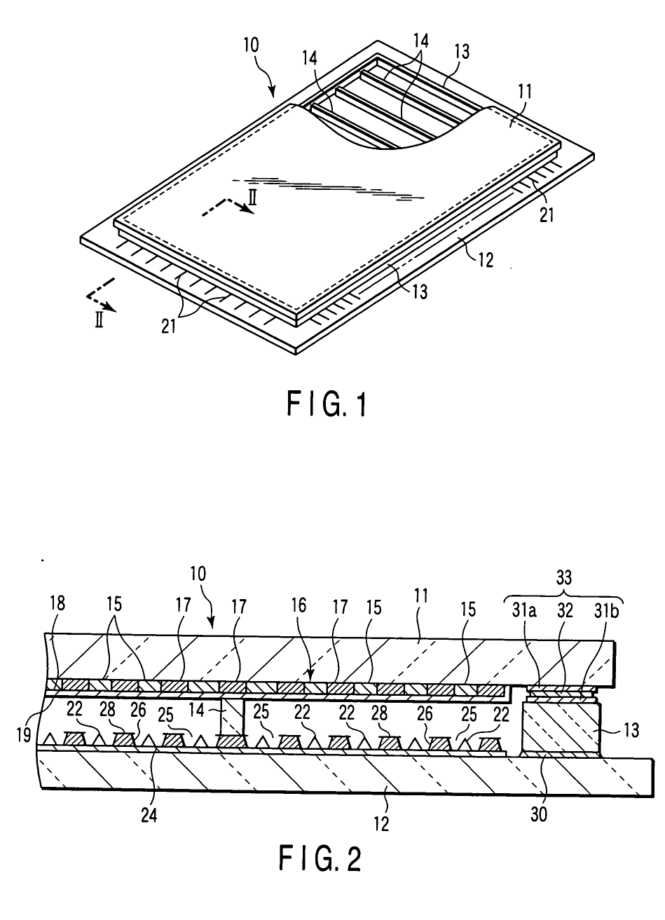

As shown in FIGS. 1 and 2, the FED comprises a first substrate 11 and a second substrate 12, which are formed of a rectangular glass substrate each. These substrates are located opposite each other with a gap of about 1.0 to 2.0 mm between them. The first substrate 11 and the second substrate 12 have their respective peripheral edge portions joined together by a sidewall 13 of glass in the form of a rectangular frame, thereby forming a flat vacuum envelope 10 the inside of which is kept evacuated.

The sidewall 13 that functions as a joint member is sealed to the peripheral edge portion of the inner surface of the second substrate 12 by a low-melting-point glass 30, such as fritted glass. As will be mentioned later, the sidewall 13 is sealed to the peripheral edge portion of the inner surface of the first substrate 11 by a seal portion 33 that contains a low-melting-point metal as a sealing material. Thus, the sidewall 13 and the seal portion 33 airtightly join together the respective peripheral edge portions of the first substrate 11 and the second substrate 12, thereby defining a sealed space between the first and second substrates.

A plurality of plate-like support members 14 of, e.g., glass are provided in the vacuum envelope 10 in order to support the atmospheric load that acts on the first substrate 11 and the second substrate 12. These support members 14 extend parallel to the short sides of the vacuum envelope 10 and are arranged at predetermined intervals in a direction parallel to the long sides. The shape of the support members 14 is not limited to this configuration, and columnar support members may be used instead.

A phosphor screen 16 that functions as a phosphor surface is formed on the inner surface of the first substrate 11. The phosphor screen 16 is provided with a plurality of phosphor layers 15, which glow red, green, and blue, and a plurality of light shielding layers 17 formed between the phosphor layers. Each phosphor layer 15 is stripe-shaped, dot-shaped, or rectangular. A metal back 18 of aluminum or the like and a getter film 19 are successively formed on the phosphor screen 16.

Provided on the inner surface of the second substrate 12 are a large number of electron emitting elements 22, which individually emit electron beams as electron sources for exciting the phosphor layers 15 of the phosphor screen 16. Specifically, a conductive cathode layer 24 is formed on the inner surface of the second substrate 12, and a silicon dioxide film 26 having a large number of cavities 25 is formed on the conductive cathode layer. A gate electrode 28 of molybdenum, niobium, or the like is formed on the silicon dioxide film 26. The electron emitting elements 22 of molybdenum, which are cone-shaped, are provided individually in the cavities 25 on the inner surface of the second substrate 12. These electron emitting elements 22 are arranged in a plurality of columns and a plurality of rows corresponding to individual pixels. In addition, a number of wires 21 for supplying potential to the electron emitting elements 22 are provided in a matrix on the second substrate 12, and their respective end portions are drawn out of the vacuum envelope 10.

In the FED constructed in this manner, a video signal is input to the electron emitting elements 22 and the gate electrode 28. A gate voltage of +100 V is applied in a state for the highest luminance based on the electron emitting elements 22. A voltage of +10 kV is applied to the phosphor screen 16. The size of electron beams emitted from the electron emitting elements 22 is modulated by the voltage of the gate electrode 28, and an image is displayed as the electron beams excite the phosphor layers of the phosphor screen 16 to luminescence. Since the high voltage is applied to the phosphor screen 16, high-strain-point glass is used as plate glass for the first substrate 11, second substrate 12, sidewall 13, and support members 14.

The following is a detailed description of the seal portion 33 that seals a space between the first substrate 11 and the sidewall 13.

As shown in FIG. 2, the seal portion 33 has a metal layer 31a, a metal layer 31b, and a sealing layer 32 of a low-melting-point metal. The metal layer 31a is in the form of a rectangular frame that extends along the peripheral edge portion of the inner surface of the first substrate. The metal layer 31b is in the form of a rectangular frame that extends along the first-substrate-side end face of the sidewall 13. The sealing layer 32 is situated between the metal layers 31a and 31b. Each of the metal layers 31a and 31b is formed of a metal that has connectivity to glass, affinity to a low-melting-point metal, and a solubility of less than 1% to a low-melting-point metal to be melted at a temperature of 500° C. or less.

The inventors hereof repeatedly studied mechanisms related to bonds between glass and metal, and systematically observed a wetting phenomenon of indium (In) as a conventionally used sealing material on glass as one of the mechanisms. In consequence, it was recognized that molten In, although wettable with glass, was induced to become hemispherical without spreading by wetting on the glass surface, owing to its high surface tension. It was noticed, therefore, that it is hard to seal a long distance with In and that a substance that fixes In in a predetermined place and relatively eases the surface tension must be provided between glass and In.

Accordingly, the inventors hereof intended to form a metal layer on the glass surface and repeated experiments using many types of metal layers. In consequence, it was recognized that many substances were separated from the glass surface as In solidified, although the surface tension of In was able to be relatively lowered when the substances are metallic. It was noticed, moreover, that the metal layers became ineffective, disappearing from the glass surface, with the passage of time when they have some solubility to In even at a low temperature lower than 500° C. Based on this, it was found that the aforesaid two problems were solvable by using materials having good adhesion to glass, low solubility to In, and good affinity to In. It was found that high vacuum sealing capacity was able to be obtained with use of other materials than In that fulfill these conditions, such as low-melting-point metals or alloys.

Effective metals that have high adhesion to glass include simple active transition metals, such as Cr, Ti, Hf, Zr, Ta, Al, etc., alloys that contain two or more of these metals each, simple rare-earth metals, such as Y, Ce, etc., or alloys that contain two or more of them each. Further, simple transition metals, such as Fe, Ni, W, Mo, etc., or alloys consisting mainly of these metals may be used as materials that have low solubility to low-melting-point metals.

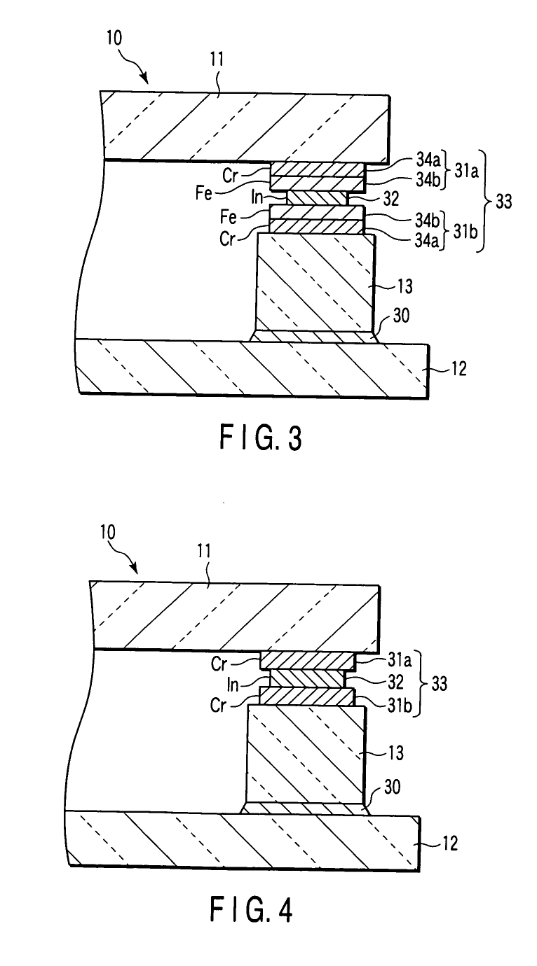

Basically, a metal layer that has the aforesaid two functions is formed by laminating a plurality of metal layers that have their respective functions. As shown in FIG. 3, for example, each of the metal layers 31a and 31b is formed by laminating a first metal layer 34a of Cr and a second metal layer 34b of Fe. Cr has high connectivity to glass, and Fe has a solubility of less than 1% to a low-melting-point metal to be melted at a temperature of 500° C. or less. In this case, the first metal layer 34a is formed on the glass surface, while the second metal layer 34b is laminated to the first metal layer and interposed between the first metal layer and the low-melting-point metal 32. If stainless steel or Cr steel is used as a vaporization source in the case where the metal layer is formed by vapor deposition, in particular, Cr as a component of those metals, having a high vapor pressure, vaporizes faster than the other component Fe or Ni. After Cr is enriched and adhered to the glass surface, therefore, Fe or Ni is formed in a superposed manner. Thus, an effect similar to that of multilayer processing can be obtained by one processing cycle.

The metal layer can produce an effect as a single layer of a form such that elements having the aforesaid two functions are mixed together. As shown in FIG. 4, for example, a single metal layer of Cr may be used as each of the metal layers 31a and 31b.

At least one kind of metal selected from In, Ga, Bi, Pb, Sn, Zn and Sb or a metal that contains Ag, Cu, Al, etc., besides them may be practically used as the low-melting-point metal or alloy. Those metals other than Al which are highly connective to the glass substrates are poorly soluble to a low-melting-point alloy and have the aforesaid two functions. However, it is effective to make these metals wettable with the low-melting-point metal to, for example, clean or coat them with a highly wettable material.

The metal layer may be located on the glass surface by any of dry processes, such as vapor deposition, sputtering, low-pressure inert atmosphere thermal spraying, etc., and wet processes, such as electroless plating. In any of these processes, a plurality of layers should be formed continuously. The metal film can be enhanced in connectivity and adhesion to glass by being heat-treated in an inert atmosphere or a reducing atmosphere after film formation.

In the present embodiment, the metal layers 31a and 31b formed individually on the respective surfaces of the first substrate 11 and the sidewall 13 serve to enhance the connectivity to glass and prevent depletion by the molten low-melting-point metal 32. In order to improve the wettability with the low-melting-point metal, moreover, it is desirable to form a metallic protective layer or a film of a substance that has affinity to the low-melting-point metal such that it can be easily alloyed with the low-melting-point metal.

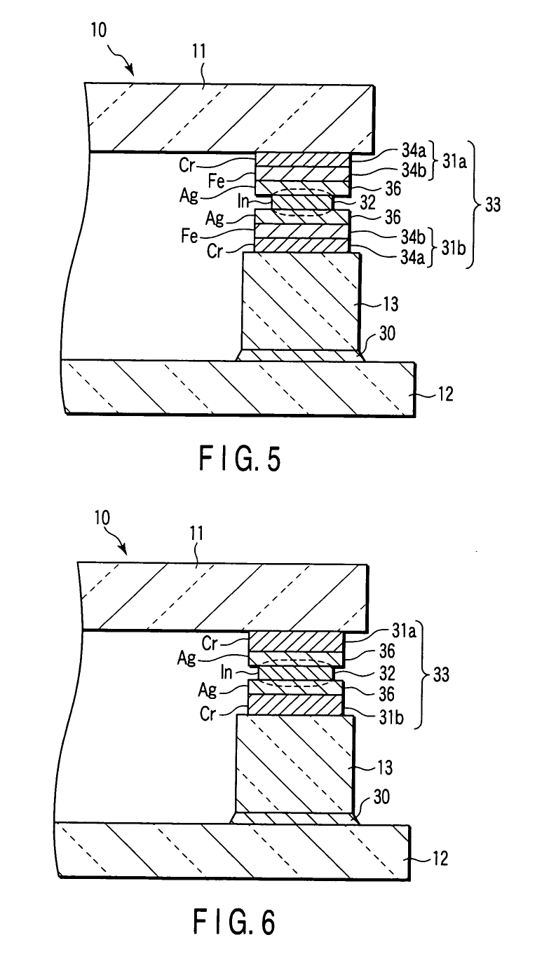

Specifically, the outermost surface layer of the metal layer becomes a nonmetallic substance based mainly on oxidation immediately after its formation, so that its wettability with the low-melting-point metal 32 for sealing may possibly lower. In order to solve this problem, therefore, the inventors hereof repeated process studies and experiments to form the metal layers 31a and 31b with high connectivity to glass, combining various materials. Thereupon, it was found that the problem was solvable by forming a metallic protective layer 36 with oxidation resistance and affinity to the low-melting-point metal immediately after the formation, that is, before the surface state changed. According to another embodiment, as shown in FIGS. 5 and 6, the metallic protective layer 36 is formed overlapping the metal layers 31a and 31b, whereby the outer surface of the metal layer is prevented from oxidation, and the metallic protective layer is provided between the metal layer and the low-melting-point metal 32. A low-melting-point metal component or a metal such as Ag, Au, Cu, Al, Pt, Pd, Ir or Sn may be effectively used as the metallic protective layer 36. In forming the metallic protective layer 36 by a dry process, it is desirable that the metallic protective layer 1 be continuously formed without being exposed to the atmosphere after the formation of the metal layers 31a and 31b.

The following is a detailed description of examples of the configuration of the FED.

### EXAMPLE 1

In order to form the FED, first and second substrates, each formed of a glass plate 65 cm long and 110 cm wide, were prepared, and the sidewall 13 of glass in the form of a rectangular frame was bonded to the peripheral edge portion of the inner surface of one of them, e.g., the second substrate, with fritted glass. Then, Cr as a first metal layer was formed to a thickness of 0.4 μm on the upper surface of the sidewall 13 and the peripheral edge portion of the inner surface of the first substrate 11, that is, in a predetermined position opposite the sidewall 13, by means of a vacuum vapor deposition apparatus. Subsequently, Fe as a second metal layer was formed to a thickness of 0.4 μm. Then, an alloy as a low-melting-point metal composed of 53% by weight of Bi and 47% by weight of Sn was melted in a nitrogen atmosphere and spread on a metal layer on the sidewall 13 by using a flatiron.

A space of 100 mm was secured between the two glass substrates, and they were heat-treated in a vacuum of 5×10⁻⁶ Pa. Since the Bi—Sin has good affinity to a film, the Bi—Si wetted. Thereafter, the two glass substrates were adhered to each other so that the position of the alloy was aligned afterward in a cooling process, whereupon the Bi—Sn alloy was made continuous with the surfaces of the two substrates. In this state, the alloy was solidified by cooling, whereupon the sidewall 13 and the first substrate were sealed together.

When the vacuum sealing properties were evaluated through a previously formed measurement hole, thereafter, a leakage of 1×10⁻⁹ atm·cc/sec or less was exhibited, proving an appropriate sealing effect. Both this result and the appearance indicate that the glass substrates suffered no internal cracks attributable to metal sealing.

### EXAMPLE 2

In order to form the FED, first and second substrates, each formed of a glass plate 65 cm long and 110 cm wide, were prepared. Subsequently, a metal layer of Cr was formed to a thickness of 0.6 μm in a predetermined place where the glass substrates face each other, that is, on the peripheral edge portion of the inner surface of each glass substrate in this case, by means of the vapor deposition apparatus. Subsequently, Cu as a metallic protective layer was formed to a thickness of 0.4 μm on the metal layer. An alloy paste as a low-melting-point metal composed of 53% by weight of Bi and 47% by weight of Sn and containing a decomposition-volatile binder was spread to a thickness of 0.3 mm on each metallic protective layer. Then, a wire (1.5 mm in diameter) of an Fe-37 weight % Ni alloy plated with Ag was set as a sidewall on the low-melting-point metal of one of the glass substrates.

A space of 100 mm was secured between the two glass substrates, and these glass substrates were temporarily fired in a vacuum of about 10⁻³ Pa at 130° C. for 30 minutes. Thereafter, the substrates were subjected to heating-deaeration treatment in a vacuum of 5×10⁻⁶ Pa. When 200° C. was then reached in the cooling process, these two glass substrates were pasted together in a predetermined position. Thereupon, the molten Bi—Sn alloy wetted and spread over the Fe—Ni alloy wire without a gap, owing to their good mutual affinity. In this state, the alloy was solidified to seal the two glass substrates together. When this FED was subjected to the same vacuum leak test as the one conducted for Example 1, the same result was obtained.

### EXAMPLE 3

First and second substrates, each formed of a glass plate 65 cm long and 110 cm wide, were prepared. Subsequently, a metal layer of Cr was formed to a thickness of 0.6 μm in a predetermined place where the glass substrates face each other, that is, on the peripheral edge portion of the inner surface of each glass substrate in this case, by means of the vapor deposition apparatus with use of 13 Cr steel as a vaporization source. Subsequently, Ag as a metallic protective layer was formed to a thickness of 0.4 μm on the metal layer. A Ti wire of 1.5-mm diameter coated with an alloy of 0.2-mm thickness, composed of 70% by weight of Bi and 30% by weight of In, as a low-melting-point metal, was set as a sidewall on the metallic protective layer of one of the glass substrates.

The two glass substrates were kept horizontal with a space of 100 mm between them, and they were subjected to heating-deaeration treatment in a vacuum of 5×10⁻⁶ Pa. When 200° C. was reached in the cooling process, these two glass substrates were joined together in a predetermined position. By this operation, thereafter, the molten Bi—In alloy wetted and spread over the Ti wire without a gap, owing to their good mutual affinity. In this state, the alloy was solidified to seal the two glass substrates together. When this FED was subjected to the same vacuum leak test as the one conducted for Example 1, the same result was obtained.

### EXAMPLE 4

First and second substrates, each formed of a glass plate 65 cm long and 110 cm wide, were prepared. Subsequently, a metal layer of Ce was formed to a thickness of 0.4 μm in a predetermined place where the glass substrates face each other, that is, on the peripheral edge portion of the inner surface of each glass substrate in this case, by means of the vapor deposition apparatus with use of Ce as a vaporization source. Subsequently, Cu as a metallic protective layer was formed to a thickness of 0.4 μm on the metal layer. An alloy paste as a low-melting-point metal composed of 53% by weight of Bi and 47% by weight of Sn and containing a decomposition-volatile binder was spread to a thickness of 0.3 mm on each metallic protective layer. Then, a wire (1.5 mm in diameter) of ferritic stainless steel (SUS 410) plated with Ag was set as a sidewall on the low-melting-point metal layer of one of the glass substrates.

A space of 100 mm was secured between the two glass substrates, and these glass substrates were temporarily fired in a vacuum of about 10⁻³ Pa at 130° C. for 30 minutes. Thereafter, the substrates were subjected to heating-deaeration treatment in a vacuum of 5×10⁻⁶ Pa. When 200° C. was then reached in the cooling process, these two glass substrates were pasted together in a predetermined position. Thereupon, the molten Bi—Sn alloy wetted and spread over the SUS 410 wire without a gap, owing to their good mutual affinity. In this state, the alloy was solidified to seal two glass substrates together. When this FED was subjected to the same vacuum leak test as the one conducted for Example 1, the same result was obtained.

### EXAMPLE 5

When In was used in place of the Bi—Sn alloy as the low-melting-point metal under the same conditions for Example 1, the same result was obtained.

### EXAMPLE 6

In order to form the FED, first and second substrates, each formed of a glass plate 65 cm long and 110 cm wide, were prepared. Subsequently, a metal layer of Cr was formed to a thickness of 0.6 μm in a predetermined place where the glass substrates face each other, that is, on the peripheral edge portion of the inner surface of each glass substrate in this case, by means of the vapor deposition apparatus. Subsequently, Ag as a metallic protective layer was formed to a thickness of 0.4 μm on the metal layer. In as a low-melting-point metal was spread to a thickness of 0.3 mm on each metallic protective layer by using an ultrasonic soldering iron. Then, a wire (1.5 mm in diameter) of an Fe-37 weight % Ni alloy plated with Ag was set as a sidewall on In of one of the glass substrates.

A space of 100 mm was secured between the two glass substrates, and these glass substrates were temporarily fired in a vacuum of about 10⁻³ Pa at 130° C. for 30 minutes. Thereafter, the substrates were subjected to heating-deaeration treatment in a vacuum of 5×10⁻⁶ Pa. When 200° C. was then reached in the cooling process, these two glass substrates were pasted together in a predetermined position. Thereupon, the molten In alloy wetted and spread over the Fe—Ni alloy wire without a gap, owing to their good mutual affinity. In this state, the alloy was solidified to seal the two glass substrates together. When this FED was subjected to the same vacuum leak test as the one conducted for Example 1, the same result was obtained.

### EXAMPLE 7

First and second substrates, each formed of a glass plate 65 cm long and 110 cm wide, were prepared. Subsequently, a metal layer of Cr was formed to a thickness of 0.6 μm in a predetermined place where the glass substrates face each other, that is, on the peripheral edge portion of the inner surface of each glass substrate in this case, by means of the vapor deposition apparatus with use of 13 Cr steel as a vaporization source. Subsequently, Ag as a metallic protective layer was formed to a thickness of 0.4 μm on the metal layer. A Ti wire of 1.5-mm diameter coated with an alloy of 0.2-mm thickness, composed of 53% by weight of Bi and 47% by weight of In, as a low-melting-point metal, was set as a sidewall on the metallic protective layer of one of the glass substrates.

The two glass substrates were kept horizontal with a space of 100 mm between them, and they were subjected to heating-deaeration treatment in a vacuum of 5×10⁻⁶ Pa. When 200° C. was reached in the cooling process, these two glass substrates were joined together in a predetermined position. By this operation, thereafter, the molten Bi—In alloy wetted and spread over the Ti wire without a gap, owing to their good mutual affinity. In this state, the alloy was solidified to seal the two glass substrates together. When this FED was subjected to the same vacuum leak test as the one conducted for Example 1, the same result was obtained.

According to the present embodiment and the individual Examples, as described above, a glass container that requires a high vacuum can be sealed, so that there may be obtained a flat image display device of improved reliability capable of maintaining a high degree of vacuum.

The present invention is not limited directly to the embodiment described above, and its components may be embodied in modified forms without departing from the spirit of the invention. Further, various inventions may be made by suitably combining a plurality of components described in connection with the foregoing embodiment. For example, some of the components according to the foregoing embodiment may be omitted. Furthermore, components according to different embodiments may be combined as required.

In the present invention, the dimensions, materials, etc., of the sidewall and other components are not limited to those of the foregoing embodiment, but may be suitably selected as required. This invention is not limited to image display devices that use electron emitting elements of the field-emission type as electron sources, but may be also applied to image display devices that use other electron sources, such as the surface-conduction type, carbon nanotubes, etc., and other flat image display devices of which the inside is kept vacuum.

What is claimed is:

1. A flat image display device comprising:
two glass substrates located opposite each other with a gap therebetween and a seal portion which seals a predetermined position on the glass substrates and defines a sealed space between the two glass substrates,
the seal portion having a low-melting-point metal filled along the predetermined position and a metal layer provided between respective surfaces of the glass substrates and low-melting-point metal and formed of a metal which has connectivity to glass, affinity to the low-melting-point metal, and a solubility of less than 1% to the low-melting-point metal to be melted at a temperature of 500° C. or less.

2. A flat image display device comprising:
two glass substrates located opposite each other with a gap therebetween and a seal portion which seals a predetermined position on the glass substrates and defines a sealed space between the two glass substrates,
the seal portion having a low-melting-point metal filled along the predetermined position, a metal layer provided between respective surfaces of the glass substrates and the low-melting-point metal and formed of a metal which has connectivity to glass, affinity to the low-melting-point metal, and a solubility of less than 1% to the low-melting-point metal to be melted at a temperature of 500° C. or less, and a protective layer provided between the metal layer and the low-melting-point metal and having affinity to the low-melting-point metal.

3. The flat image display device according to claim 2, wherein the protective layer is formed of at least one simple substance, Ag, Au, Al, Pt, Pd, Ir and/or Sn, or an alloy consisting mainly of said substances.

4. The flat image display device according to claim 1, wherein the metal layer is formed of an active transition metal which contains as a main component at least any one of substances including Cr, Ti, Hf, Zr, Ta and Al, a rare-earth metal which contains Y and/or Ce, or an alloy which consists mainly of said metals.

5. The flat image display device according to claim 1, wherein the metal layer is formed of a simple transition metal which contains at least one of substances including Fe, Ni, W and Mo or an alloy which consists mainly at least one of said metals and contains the active metal according to claim 4.

6. The flat image display device according to claim 1, wherein the metal layer is a metallic multilayer formed by laminating a plurality of metal layers together.

7. The flat image display device according to claim 6, wherein the metal layer includes a first metal layer formed on the glass substrate surfaces and having connectivity to glass and a second metal layer laminated to the first metal layer, provided between the first metal layer and the low-melting-point metal, and formed of a metal which has affinity to the low-melting-point metal and a solubility of less than 1% to the low-melting-point metal to be melted at a temperature of 500° C. or less.

8. The flat image display device according to claim 7, wherein the first metal layer is formed of a simple active transition metal which contains at least one of substances including Cr, Ti, Hf, Zr, Ta and Al, a simple rare-earth metal which contains Y and/or Ce, or an alloy which consists mainly at least one of said metals.

9. The flat image display device according to claim 7, wherein the second metal layer is formed of a simple transition metal which contains at least one of substances including Fe, Ni, W and Mo or an alloy which consists mainly at least one of said metals.

10. A flat image display device according to claim 1, wherein the low-melting-point metal is a single metal which contains at least one of substances including In, Ga, Bi, Sn, Pb and Sb or an alloy of at least one of said metals.

11. A flat image display device according to claim 1, which comprises a phosphor layer provided on an inner surface of one of the glass substrates and a plurality of electron sources which are provided on an inner surface of the other glass substrate and excite the phosphor layer.
